(19) United States
(12) Patent Application Publication
(10) Pub. No.: US 2012/0032809 A1
(43) Pub. Date: Feb. 9, 2012

(54) METHOD OF DETECTING AN ICING STATE OR A NEED FOR MAINTENANCE IN A TURBOMACHINE FUEL CIRCUIT

(75) Inventors: Fabrice Bruno Comotto, Brie Comte Robert (FR); Marion Maud De Giacomoni, Thiais (FR); Cedrik Djelassi, Marolles en Hurepoix (FR); Franck Godel, Chartrettes (FR)

(73) Assignee: SNECMA, PARIS (FR)

(21) Appl. No.: 13/264,432

(22) PCT Filed: Apr. 12, 2010
(86) PCT No.: PCT/FR10/50698

§ 371 Date: Oct. 14, 2011

(30) Foreign Application Priority Data
Apr. 14, 2009 (FR) 0952421

(51) Int. Cl. G08B 19/02

(52) U.S. Cl. 340/581

(57) ABSTRACT

Detecting a state of icing in a turbomachine fuel circuit includes reading information representative of a first temperature T₁ of the fuel downstream from the metering unit, and of comparing the first temperature T₁ with a first reference temperature T₀₁. The method also includes detecting clogging of the filter unit. In the event of the temperature reading T₁ being less than the first reference temperature T₀₁ and of clogging being detected, a signal indicative of an icing state in the fuel circuit is issued. Information representative of a second fuel temperature T₂ in the tank may be read and compared with a reference temperature T₀₂ in order to confirm or contradict the icing state. A signal indicating a need for maintenance of the fuel circuit is issued when the temperature readings T₁ and T₂ are not less than the reference temperatures T₀₁ and T₀₂ and clogging has been detected.

### BACKGROUND OF THE INVENTION

The present invention relates to a method of detecting an icing state or a need for maintenance in a turbomachine fuel circuit. The invention is applicable to any type of turbomachine, whether stationary or for aviation, and it is more particularly suitable for airplane turbojets.

The presence of water in a fuel circuit of a turbomachine is inevitable, but its impact varies as a function of operating and ambient conditions. More particularly in an airplane, the pressures and temperatures that are encountered during a flight may cause the water to pass into the solid state and can lead to serious complications in the fuel circuit.

The metering unit of the fuel circuit that has the function of delivering fuel at a controlled flow rate to the combustion chamber is in danger of having its flow rate regulation function disturbed by the presence of solid particles.

Furthermore, the presence of ice may give rise to disturbances in the system for controlling variable-geometry components (in particular the variable pitch vanes in the stator portion of a compressor, or compressor discharge valves) since the control system uses fuel as the hydraulic fluid for servo-valves and actuators associated with the variable-geometry components.

Finally, the presence of ice may lead to the fuel filters clogging. If that occurs, a safety system does indeed open a bypass duct to allow fuel to flow without being filtered, however that can clearly be harmful for the operation of the turbomachine, in particular to the injectors in the combustion chamber.

Thus, the presence of ice in the fuel circuit can disturb the regulation of the turbomachine, and can even lead to a loss of power.

Document U.S. Pat. No. 2,925,712 discloses taking a stream of air taken from the compressor to heat the fuel when clogging of the fuel filter is detected (as a result of an excessive pressure difference between the inlet and the outlet of the filter) or when the temperature in the fuel circuit is below a threshold.

Heating the fuel when the temperature upstream from the main pump is below a threshold or when clogging of the fuel filter is detected is also described respectively in document U.S. Pat. No. 3,049,878 and document GB 881 002.

### OBJECT AND SUMMARY OF THE INVENTION

The present invention proposes providing a method of detection that uses elements that are conventionally to be found in a turbomachine fuel circuit, possibly adding one or more sensors thereto, so as to act as a function of magnitudes that are read and of comparisons between those values and reference values, in order to deliver information that indicates in reliable manner that a state of icing is present, and possibly also information indicating that there is a need for maintenance of the fuel circuit.

The present invention thus relates to a method of detecting a state of icing in a turbomachine fuel circuit, said circuit comprising at least a tank, a filter unit for filtering the fuel, a high pressure pump connected to the tank via the filter unit and a fuel metering unit connected to the outlet from the high pressure pump in order to control the flow rate of fuel for injection into the combustion chamber, the method comprising:
a step of reading information representative of a first temperature T₁ of the fuel in the fuel circuit downstream from the metering unit, and of comparing the first temperature T₁ with a first reference temperature T₀₁;
a step of detecting clogging of the filter unit; and
in the event of the temperature reading T₁ being less than the first reference temperature T₀₁, and in the event of clogging being detected, issuing a signal indicative of an icing state in the fuel circuit.

The term “fuel circuit downstream of the metering unit” is used herein to mean any location situated between the metering unit and the injectors of the combustion chamber.

The method of the invention makes it possible to avoid issuing a signal in untimely manner indicating that there is a state of icing in the event of the fuel temperature downstream from the metering unit being low but the filter not being significantly clogged (no great presence of ice) and in the event of the filter being clogged but the temperature of the fuel downstream from the metering unit not being low (clogging then being due to impurities other than ice).

Thus, since information concerning the icing state of the fuel circuit is provided in reliable manner by the method of the invention, the pilot or the engine regulator circuit can control a modification to the operation of the turbomachine in order to take account of the presence of ice or in order to eliminate it. For example, the speed of the engine may be slowed in order to heat up the entire engine, and in particular its lubricating oil, thereby increasing the temperature of the fuel via oil/fuel heat exchangers that are used in the engine.

Advantageously, the method of the invention further comprises:
a step of reading information representative of a second temperature T₂ of the fuel in the tank, and of comparing the second temperature T₂ with a second reference temperature T₀₂; and
issuing the signal indicating that there is an icing state in the fuel circuit on the additional condition of the second temperature T₂ being less than the second reference temperature T₀₂.

According to a feature of the method, a signal indicating a need for maintenance on the filter unit is issued when clogging is detected and so long as the temperatures T₁ and T₂ are not less than the respective reference temperatures T₀₁ and T₀₂. This avoids triggering untimely maintenance if a detected clogging state of the filter unit is due to the presence of ice.

Other features of the method of detection are given below:
the reference temperatures are equal to 0° C. (Celsius)±5° C.;
in a first possibility, the filter unit includes a bypass duct that opens in the event of clogging to allow fuel to pass without being filtered, and the step of detecting clogging is performed by detecting that the bypass duct is in the open state;
in a second possibility, the step of detecting clogging is performed by reading information representative of the pressure difference ΔP₁ between the inlet pressure Pₑ and the outlet pressure Pₛ of the fuel at the filter unit, and by comparing the pressure difference ΔP₁ with a reference pressure difference ΔP₀₁; and
in this second possibility, the reference pressure ΔP₀₁ is selected to lie in the range 0.4 bar to 3 bar, and preferably in the range 1.3 bar to 1.7 bar.

### BRIEF DESCRIPTION OF THE DRAWINGS

Other characteristics and advantages of the invention appear better on reading the following description of preferred implementations of the invention given as non-limiting examples. The description refers to the accompanying drawings, in which:

FIG. 1 is a diagrammatic view of a fuel circuit; and

FIG. 2 is a flow chart illustrating the method of the invention in the event of an icing state being detected and in the event of a need for maintenance being detected.

### DETAILED DESCRIPTION OF IMPLEMENTATIONS

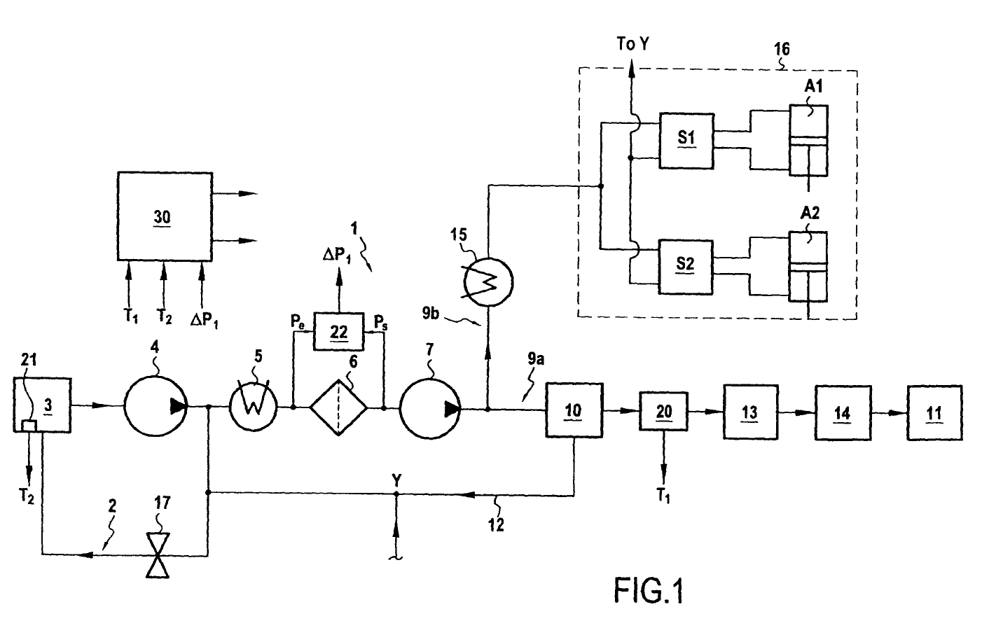

FIG. 1 shows a fuel circuit 1 of an airplane turbojet.

The circuit 1 comprises, in the fuel flow direction: a low-pressure pump 4, a first heat exchanger 5, a main filter unit 6, and a high-pressure pump 7. The low-pressure pump 4 is connected at its upstream end to the fuel tank 3 of the airplane. Downstream from the high-pressure pump 7, the circuit 1 separates into two branches 9a and 9b.

The first branch 9a includes a metering unit 10 serving to regulate the flow rate of fuel injected into the combustion chamber 11 of the turbojet, and returning excess fuel to the fuel circuit, upstream from the heat exchanger 5 via a recirculation loop 12. This metering unit 10 is generally a hydromechanical unit (HMU). Between the metering unit 10 and the combustion chamber 11, there are conventionally to be found a flow meter 13 for measuring the flow rate of fuel taken to the injectors in the combustion chamber 11, a fuel cut-off valve 14, in particular for cutting off the supply of fuel in the event of overspeed being detected, and injector filters and injector valves (not shown).

The second branch 9b comprises a second heat exchanger 15 and a variable-geometry control system 16. By way of example, the variable-geometry components may be air-discharge valves or variable-pitch vanes enabling the configuration of the turbojet compressor to be adapted as a function of its operating speed.

The variable-geometry control system 16 comprises one or more hydraulic actuators A1 to AN that are mechanically connected to the variable-geometry components that are to be controlled, where N represents an integer greater than or equal to 1. In the example, only two actuators A1 and A2 are shown. The variable-geometry control system 16 also comprises a plurality of servo-valves referenced S1 to SN (in the example S1 and S2), each actuator A1, A2 being controlled by a respective servo-valve S1, S2. Fuel is used as the hydraulic fluid and the high-pressure ports are connected to the branch 9b, while the low-pressure ports are connected to the recirculation loop 12 (point Y).

A fuel return circuit 2 includes a fuel return valve 17 serving to control the flow rate of the fuel returning to the airplane tank 3. The return circuit 2 is connected between the outlet of the low-pressure pump 4 and the tank 3.

In the first and second heat exchangers 5 and 15, there flows firstly the fuel, and secondly lubricating oil from various members of the turbojet, with the fuel serving to cool the oil.

As explained above, the method of the invention may use elements that are conventionally present in a fuel circuit 1 of a turbomachine, more particularly of an airplane turbojet, or it may use additional elements.

A temperature sensor 20 that is not originally present in a conventional turbojet fuel circuit is arranged in the fuel circuit downstream from the metering unit 10, e.g. immediately at the outlet from the metering unit 10, it being understood that any other location between the metering unit 10 and the injectors of the combustion chamber could be selected for the temperature sensor 20.

The temperature sensor 20 provides information representative of the temperature T₁ of the fuel where the sensor is located. A processor circuit 30 receives the information provided by the sensor 20 and is arranged to compare the temperature T₁ with a reference temperature T₀₁ in order to detect that there is a probability of ice being present in the fuel contained in the circuit whenever T₁<T₀₁. The reference temperature T₀₁ may be selected to be equal to about 0° C., however it is also possible to use a reference temperature T₀₁ that is slightly different, e.g. about 0° C.±5° C.

Furthermore, the main filter unit 6 includes means suitable for detecting clogging of said unit 6. Clogging may result from the presence of a relatively large amount of ice in the fuel or from a relatively large accumulation of other impurities conveyed by the fuel. Below, it is explained how the invention makes it possible to distinguish between a clogging state due to the presence of ice in the fuel circuit and a state in which a maintenance operation is required on the filter unit 6 because of the presence of other impurities. Clogging of the filter unit 6 may be detected herein in two ways.

In a first possibility, a bypass duct (not shown in the accompanying figures) opens in conventional manner to allow the fuel to flow freely without passing via the filter(s) of the filter unit 6 when the filter unit is blocked, at least in part, i.e. when the pressure difference between the inlet and the outlet of the filter unit 6 increases above a trigger threshold that authorizes the bypass duct to be opened by using conventional hydromechanical means. The processor circuit 30 receives information indicating that the bypass duct is open or closed, e.g. by detecting the position of the closure member of said duct. When the processor circuit 30 receives information that the bypass duct is open, then clogging of the filter unit 6 has been detected.

In a second possibility, the main filter unit 6 is associated with a clogging detector typically in the form of a sensor 22 for sensing the pressure difference ΔP₁ between the inlet (pressure Pₑ) and the outlet (pressure Pₛ) of the filter unit 6. The processor circuit 30 receives information representative of ΔP₁ from the sensor 22 and is arranged to compare ΔP₁ with a reference value ΔP₀₁ in order to detect clogging when ΔP₁>ΔP₀₁. By way of example, the reference value ΔP₀₁ is selected to lie in the range 0.4 bar to 3 bar, and preferably in the range 1.3 bar to 1.7 bar.

In optional but advantageous manner, information representative of a second temperature T₂ of the fuel is used for confirming/contradicting a diagnosed icing state of the fuel circuit performed on the basis of the first temperature T₁ and detecting clogging of the filter unit 6. This second temperature T₂ is advantageously measured in the tank 3.

It is possible to use a temperature sensor 21 as is conventionally fitted to the tank 3. The temperature sensor 21 provides information representative of the temperature T₂ of the fuel in the tank 3.

The temperature T₂ is compared in the processor circuit 30 with a reference temperature T₀₂. A signal indicating an icing state in the fuel circuit 1 is effective only if in addition to the conditions relating to T₁ and the clogging state of the filter unit 6, the temperature T₂ is less than a reference temperature T₀₂. The reference temperature T₂ may be set in the same manner as the reference temperature T₀₁. This may serve to avoid untimely detecting of icing if the clogging of the filter unit is due to impurities other than ice and if the temperature reading T₁ is faulty.

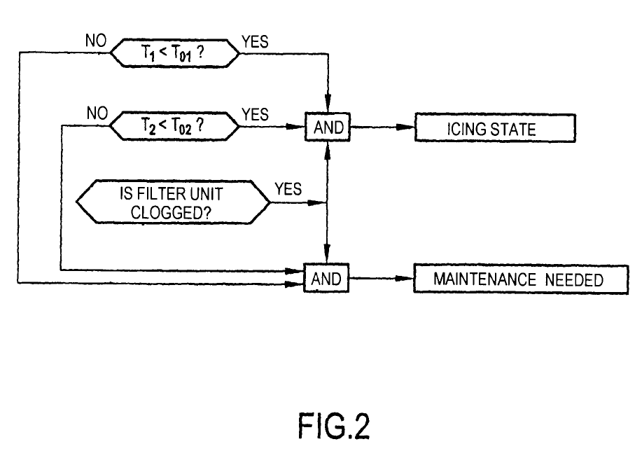

As shown in FIG. 2, when the processor circuit 30 detects simultaneously the conditions T₁<T₀₁, T₂<T₀₂, and clogging of the filter unit, a signal is issued indicating a state of icing in the fuel circuit, since the first two conditions represent the existence of icing conditions and the third condition represents a significant and disturbing probability that ice is present. FIG. 2 shows the situation in which the method of detection uses at least two temperature readings, T₁ and T₂, however it will naturally be understood that the icing state could be detected on the basis of the single temperature reading T₁ together with detection of clogging in the filter unit 6.

The method of the invention also makes it possible to diagnose more reliably the need for maintenance to be performed on the filter unit 6 of the fuel circuit.

Thus, as shown in FIG. 2, if a clogging state is detected in the filter unit 6 while the information provided by the sensors 20 and 21 concerning the temperatures T₁ and T₂ does not represent an icing state (temperatures T₁ and T₂ respectively not less than the reference treatments T₀₁ and T₀₂), then it is likely that solid particles other than ice have accumulated in the filter(s) of the filter unit 6, such that a maintenance operation is needed.

Compared with using a single temperature reading T₁, reading two temperatures T₁ and T₂ serves to make detection of an icing state more reliable and to avoid untimely delivery of a signal indicating that there is a need for maintenance.

The application of particular corrective measures in response to detecting a state of icing in the fuel circuit does not come within the ambit of the invention. For example, it is possible to slow down the engine speed, thereby increasing the temperature of the engine and the temperature of the fuel as a result of heat exchange between the turbojet lubricating oil and the fuel in the heat exchangers 5, 15. It is also possible to modify the maximum and minimum richness thresholds of the injected fuel (or acceleration and deceleration stops) in order to make the operation of the turbojet safer.

1-7. (canceled)

8. A method of detecting a state of icing in a turbomachine fuel circuit, said circuit comprising at least a tank, a filter unit for filtering the fuel, a high pressure pump connected to the tank via the filter unit and a fuel metering unit connected to the outlet from the high pressure pump in order to control the flow rate of fuel for injection into the combustion chamber, the method comprising:
reading information representative of a first temperature T₁ of the fuel in the fuel circuit downstream from the metering unit, and of comparing the first temperature T₁ with a first reference temperature T₀₁;
detecting clogging of the filter unit; and
in the event of the temperature reading T₁ being less than the first reference temperature T₀₁ and of clogging being detected, issuing a signal indicative of an icing state in the fuel circuit.

9. The method according to claim 8, further comprising:
reading information representative of a second temperature T₂ of the fuel in the tank, and of comparing the second temperature T₂ with a second reference temperature T₀₂; and
issuing the signal indicating that there is an icing state in the fuel circuit on the additional condition of the second temperature T₂ being less than the second reference temperature T₀₂.

10. The method according to claim 9, wherein a signal indicating a need for maintenance on the filter unit is issued when clogging is detected and so long as the temperatures T₁ and T₂ are not less than the respective reference temperatures T₀₁ and T₀₂.

11. The method of detection according to claim 9, wherein the reference temperatures are equal to 0° C.±5° C.

12. The method according to claim 8, wherein the filter unit includes a bypass duct that opens in the event of clogging to allow fuel to pass without being filtered, and the detecting clogging is performed by detecting that the bypass duct is in the open state.

13. The method according to claim 8, wherein the detecting clogging is performed by reading information representative of the pressure difference ΔP₁ between the inlet pressure Pₑ and the outlet pressure Pₛ of the fuel at the filter unit, and by comparing the pressure difference ΔP₁ with a reference pressure difference ΔP₀₁.

14. The method according to claim 13, wherein the reference pressure ΔP₀₁ is selected to lie in the range 0.4 bar to 3 bar.

15. The method according to claim 13, wherein the reference pressure ΔP₀₁ is selected to lie in the range 1.3 bar to 1.7 bar.
